(19) United States
(12) Patent Application Publication
(10) Pub. No.: US 2009/0103084 A1
(43) Pub. Date: Apr. 23, 2009

(54) OXYGEN SENSOR FOR USE IN HARSH, ESPECIALLY HIGH, pH ENVIRONMENTS

(75) Inventors: Omowunmi A. SADIK, Vestal, NY (US); Hongwu XU, Johnson City, NY (US)

Correspondence Address: NIXON PEABODY LLP - PATENT GROUP, 1100 CLINTON SQUARE, ROCHESTER, NY, 14604, US

(73) Assignee: Research Foundation of State University of New York, Binghamton, NY (US)

(21) Appl. No.: 12/259,819

(22) Filed: Oct. 28, 2008

Related U.S. Application Data
(63) Continuation of application No. 10/745,246, filed on Dec. 23, 2003, now abandoned.

(51) Int. Cl. G01J 3/30

(52) U.S. Cl. 356/318

(57) ABSTRACT

An oxygen sensor usable and accurate in solutions of up to pH 14 is featured. The sensor is fabricated by immobilizing a layer of polystyrene mixed with a fluorophore (e.g., Ruthenium tris(4,7-diphenyl-1,10-phenanthroline) dichloride) in a solvent such as dichloromethane. The mixture may be coated onto a structure such as a stainless steel sensor probe. In typical use, the inventive sensor probe is inserted into a flow cell through which the solution to be monitored flows. A blue LED light source having a wavelength of approximately 470 nm, and a spectrophotometer detector complete the sensor system. In operation, the fluorophore layer of the probe is illuminated by a blue LED light and the fluorescence is reflected back to the spectrophotometer. The monitored solution, typically an electroless gold plating bath, is pumped from the process equipment through the flow cell, and then back to the solution's origin.

This application is a continuation of U.S. patent application Ser. No. 10/745,246, filed Dec. 23, 2003, which is hereby incorporated by reference in its entirety.

### FIELD OF THE INVENTION

The present invention relates to oxygen sensors and, more particularly, to oxygen sensors adapted for use in harsh environments such as high pH environments.

### BACKGROUND OF THE INVENTION

Many industrial processes require accurate measurements of oxygen. These processes typically involve the use of alkaline solutions that have high pH values. Typical of such processes is the plating of gold using either electroless or electrolytic methods. In addition to such industrial processes, oxygen sensing is important in such other fields as steam boilers, where control of the oxygen content of the water in steam pipes is critical to minimizing corrosion.

Most known, commercially available oxygen sensors are not usable in solutions having a pH greater than about 9.0. Traditionally, dissolved oxygen is detected by a chemical method called the Winkler Method, which is well known to those of skill in the art. In this method, Mn²⁺ is oxidized into MN³⁺ by the dissolved oxygen in alkaline solution, then the solution is acidified and I⁻ is added. The I⁻ is oxidized into I₂ quantitatively and the resulting I₂ is titrated with S₂O₃²⁻ iodometrically:

Mn²⁼+2OH⁻→Mn(OH)₂

4Mn(OH)₂+O₂→4Mn (OH)₃

2Mn(OH)₃+6H⁺+3I⁻→2Mn²⁺+I₃⁻+6H₂O

I₃⁻+2S₂O₃²⁻→3I⁻+S₄O₆²⁻

Because the solution needs to be alkaline and acidified when using this method, the pH must be controlled with care. Metal ions present typically react with hydroxide to form metal hydroxide. In addition, it is required that atmospheric oxygen should not dissolve in the sample. However, in the last two steps, I₂ is subject to oxidation by oxygen present in air, and this may result in higher than expected results. Moreover, iodine is volatile and the loss of iodine in vapor form may result in lower than expected results.

These factors affect the precision of the Winkler Method and careful and quick operation is needed to obtain reliable data. In order to increase accuracy and ease of operation, some workers have presented different modifications to this technique. For example, Rideal et al. used KmnO₄ and KC₂C₂O₄ to eliminate the effect of Fe²⁺ and Fe³⁺, but among all the modifications, I₂ was generated, so the error from I₂ is typically present.

Since the reduction of oxygen is co-related to the transfer of electrons, electrochemical methods are also employed, which are based on the Clark electrode. In this approach, the working electrode (cathode) such as a platinum electrode is isolated from the matrix solution by a polymer film, and the oxygen in the sample solution permeates into the film and is reduced on the electrode surface. The film keeps impurities away from the electrode. There may be one or two electrolyte reservoirs in the electrode setup, and a thin film of electrolyte solution exists between the electrode and the membrane. After oxygen permeates into the electrode setup, it is dissolved in the electrolyte solution and is reduced. The reduction product of oxygen depends on the pH of the electrolyte solution. In neutral or acidic medium, oxygen is reduced into H₂O and in basic medium, oxygen is reduced into OH⁻.

Other electrochemical sensors have been developed based on polarography using dropping mercury electrode, coulometry and conductometry. The problems associated with the commercial electrodes are mainly the reproducibility concerns that affect the performance of the film. In addition, under certain conditions, the film may be poisoned, particularly in harsh systems found in an electroless gold plating bath (with high pH), the electrode may degrade or perform poorly. At high pH, the electrode may be etched and the lifetime shortened. Finally, as shown in the half reactions, oxygen is consumed during the detection. Thus, the oxygen content detected by such an electrode is usually lower than the true value of oxygen concentration present in the medium.

Another method used to determine dissolved oxygen is spectrophotometry. In this method, a reagent in the reduced form is oxidized by the dissolved oxygen and is determined by spectrophotometric measurement. The amount of the oxidation product is used to estimate the amount of oxygen. In the indigo-carmine test known to those of skill in the art, for example, the reduced form of indigo-carmine, which is bright yellow-green, is oxidized by the dissolved oxygen into the intense blue-green oxidation form that is detected spectrophotometrically. The amount of dissolved oxygen can be calculated from the relation in the reaction.

These chemical methods are often reliable and precise. However, the measurements often contain several steps such as sampling, reacting with reagents and titration or detection, which are time consuming and may be subject to the introduction of interference. Furthermore, these approaches are not suitable for in-situ determinations. Hence, the present invention provides methods for the in-situ measurements of dissolved oxygen, particularly in the harsh chemical environment found in electroless gold plating baths. The present invention provides a fiber optic oxygen sensor for application at high pH.

The inventive sensor, on the other hand, suffers none of the problems of prior art sensors and is useful and accurate in solutions as high as pH 14. The inventive sensor is also useful in neutral (i.e., having a pH of approximately 7.0) solutions. Another advantage of the inventive sensor is that it may be used in a mode wherein it consumes none of the solution it samples. Oxygen content may be quickly measured, allowing the inventive sensor to be used in real-time oxygen monitoring systems. Because the inventive sensor may be used in continuous monitoring systems, no sample preparation is required, and because the sensor is chemically inert, no contamination of a solution such as a plating bath occurs.

### DISCUSSION OF THE RELATED ART

U.S. Pat. No. 6,251,342, issued Jun. 26, 2001 to Chaitanya Kumar Narula et al. for FLUORESCENT FIBER OPTIC SENSOR ELEMENT FABRICATED USING SOL-GEL PROCESSING TECHNIQUES, teaches a method for producing an oxygen sensor using sol-gel deposition techniques. In contradistinction, the inventive sensor dissolves the fluorophore in a solvent along with a polymer such as polystyrene.

U.S. Pat. No. 6,354,134, issued Mar. 12, 2002 to Tooru Katafuchi et al. for OXYGEN SENSING ELEMENT USED IN A OXYGEN SENSOR, teaches both a sensing electrode and a reference electrode in a reference gas chamber. A heating element is also included. This is a significantly different structure than the solvent-dissolved polystyrene/fluorophore composition, which is air-dried onto a probe tip of the instant invention.

None of the prior art taken individually or in combination is seen to teach or suggest the novel oxygen sensor of the present invention.

### SUMMARY OF THE INVENTION

In accordance with the present invention, an oxygen sensor usable and accurate in solutions of up to pH 14 is provided. The sensor is fabricated by immobilizing a layer of polystyrene mixed with a fluorophore (e.g., Ruthenium tris(4,7-diphenyl-1,10-phenanthroline) dichloride on a surface. This may be accomplished by dissolving the polystyrene and the fluorophore in a solvent such as dichloromethane and coating it onto a structure such as a stainless steel sensor probe, which is then typically air-dried overnight. After drying, the sensor probe is ready for use.

In typical use, the inventive sensor probe is inserted into a flow cell through which the solution to be monitored flows. The probe is coupled with a light source of a specific, predetermined frequency and a spectrophotometer to form a complete detection system. A blue LED light source having a wavelength of approximately 470 nm, coupled with an optical fiber, forms a typical light source.

In operation, the blue LED light illuminates the fluorophore layer of the inventive probe and the fluorescence is reflected back to the spectrophotometer for analysis. The monitored solution is pumped from the desired area of the process equipment, through the flow cell, and then may be sent back to the solution's origin. A typical solution is an electroless gold plating bath. Using the inventive sensor, real-time, on-line detection of the oxygen in the monitored solution is achieved, and no sample solution is necessarily consumed. The ease of fabrication of the probe and the simplicity of its installation make the inventive probe suitable for on-line industrial application. The on-line detection eliminates the time, consumption of the sampled material, and possible contamination in preparing industrial samples as typically seen in oxygen measurements of the prior art.

It is therefore an object of the invention to provide an oxygen sensor that is useful in monitoring oxygen in a solution having pH values in the range of approximately 7 to as high as 14.

It is another object of the invention to provide an oxygen sensor, which may be used in real-time by quickly providing an oxygen reading.

It is a further object of the invention to provide an oxygen sensor using a spectrophotometer responsive to fluorescent emissions of the sensor in the presence of a light source.

It is yet another object of the invention to provide an oxygen sensor utilizing a light source emitting light having a wavelength of approximately 470 nM.

It is a still further object of the invention to provide an oxygen sensor utilizing an LED light source.

It is an additional object of the invention to provide an oxygen sensor that may be readily fabricated.

It is another object of the invention to provide an oxygen sensor that is substantially inert and does not contaminate a solution into which it is placed.

### BRIEF DESCRIPTION OF THE DRAWINGS

A complete understanding of the present invention may be obtained by reference to the accompanying drawings, when considered in conjunction with the subsequent detailed description, in which:

FIG. 1 is a front, elevational schematic view of the probe of the invention;

FIG. 2a is schematic molecular structure of gold compound JM-6277;

FIG. 2b is schematic molecular structure of gold compound JM-62807;

FIG. 3a show the spectrum of the JM-6277 solution on glass slide;

FIG. 3b shows the spectrum of the JM-6280 solution on glass slide;

FIG. 3c shows the spectrum of the JM-6277 solution on immobilized onto the fiber-optic tip;

FIG. 3d shows the spectrum of the JM-6280 solution immobilized onto the fiber-optic tip;

FIGS. 4a and 4b are Stern-Volmer plots for the JM-6277 and JM-6280 sensors, respectively;

FIGS. 5a and 5b show the real-time response and recovery profiles for JM-6277 and JM-6280 sensors, respectively;

FIG. 6 shows the fluorescence of QABA (4-(3-quinolinoazo) hydroxybenzoic acid) in the dichloromethane solution purged with nitrogen (without oxygen in the solution) and with air (with oxygen in the solution);

FIG. 7 shows a sensor tip immobilized with Ru(dpp)₃Cl₂;

FIG. 8 is the UV/Vis absorbance spectra of Ru(dpp)₃Cl₂;

FIG. 9 is a plot of intensity vs. wavelength for the sensor composition of FIG. 7;

FIG. 10 is the fluorescence spectra of 1×10-5 M (Ru(dpp)₃Cl₂ in CH₂Cl₂ solution purged with nitrogen and air;

FIG. 11 shows the fluorescence spectra of the sensor in nitrogen and air;

FIG. 12 shows the fluorescence spectra of the sensor in aqueous solution;

FIG. 13 is a front elevational view of a first embodiment of a typical oxygen sensor probe in accordance with the invention; and

FIG. 14 is a schematic system block diagram of the oxygen sensor probe of FIG. 13 in its intended operating environment.

### DETAILED DESCRIPTION OF THE PREFERRED EMBODIMENT

### Theory of Fiber Optic Sensors

The optic fiber is a kind of glass light that carries light from place to place. The fiber is often composed of a core made of glass to transmit light, a layer of antireflection cladding (coating) made of another glass or polymer with low refractive index, and a plastic jacket to protect the glass core and coating. In the fiber, the refractive index of the core, n₁, should be larger than that of the coating, n₂. Considering the light entering the core at a predetermined angle of incidence θ₁, some light will be reflected within the core and some will be entering the coating with the angle of refraction, θ₂. According to Snell's Law, n₁ sin Θ₁=n₂ sin Θ₂, and

$$sin {Θ}_{2} = \frac{{n}_{1}}{{n}_{2}} sin {Θ}_{1} .$$

### If

$${n}_{1} > {n}_{2} , \frac{{n}_{1}}{{n}_{2}} > 1 ,$$

there will be a critical angle θ₁, where

$$\frac{{n}_{1}}{{n}_{2}} sin Θ = 1.$$

In this circumstance, sin θ₂=1 means that θ₂=90° and consequently, there will be no light entering the coating. Since sin θ₂≦1, if θ₁ is larger and

$$\frac{{n}_{1}}{{n}_{2}} sin {Θ}_{1} = 1 ,$$

the light will be reflected completely without refraction. So there will be an angle of acceptance that all light will be reflected inside the core and little is lost in the transfer of light. This property makes it possible for the fiber to transfer light and may be suitable for remote monitoring. If one or more detecting reagents are immobilized on one end of the fiber and the fiber end is placed in the matrix containing the analyte, the light reflected back can be used to analyze the chemistry of the analyte. Such a sensor is called an optrode or an optode.

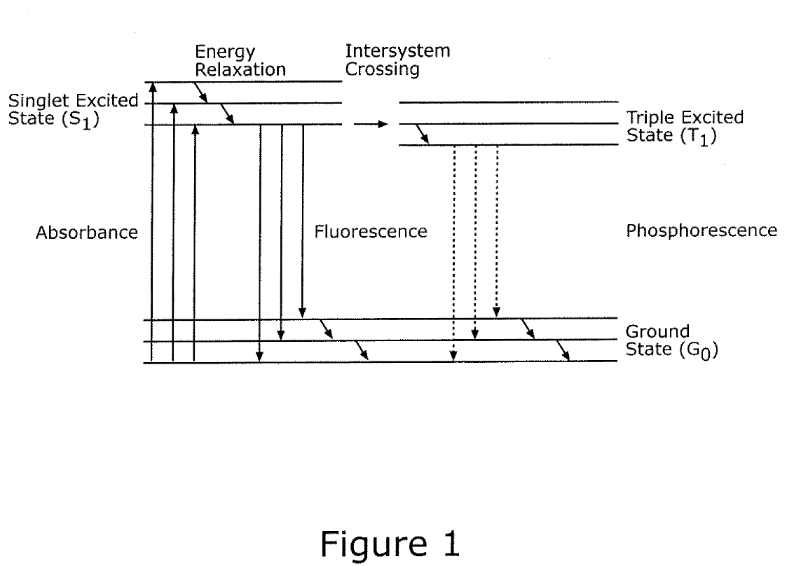

In the optodes, UV/Vis, visible, infrared (IR) or luminescence (fluorescence and phosphorescence) are used for detection. For the optic oxygen sensor of the present invention, most often the luminescence of the reagent is used to detect oxygen. The energy relations for the generating luminescence consisting of fluorescence and phosphorescence are shown in FIG. 1.

FIG. 1 shows the energy relations among S₀, S₁, and T₁. When a ground electronic state (S₀) molecule absorbs light, that molecule is promoted to the excited singlet (S₁) or triplet (T₁) state with the most and least probability, respectively. The molecule will relax to the lowest energy state of S₁ or T₁. The energy of the molecule at S₁ or T₁ can be converted to heat by going back to S₀ via internal conversion, intersystem crossing, and radiationless relaxation. There is no radiation in the process. If the molecule in S₁ or T₁ relaxes back to S₀ by radiating one photon, the transition is called fluorescence (S₁→S₀) or phosphorescence (T₁→S₀). Some of the energy of an excited molecule at S₁ or T₁ can also be transferred to another molecule such as oxygen and the molecule returns to S₀. In this way, there is little or no radiation, and the luminescence (fluorescence or phosphorescence) is quenched.

Most optical oxygen sensors are based on the decrease in fluorescence or phosphorescence intensity of the chromophores (indicators) when they are quenched by molecular oxygen in either gas phase or in dissolved form. Some sensors are based on the fluorescence lifetime decrease upon exposure to oxygen. The relationship between the intensity or lifetime in the absence (I₀, τ₀) and presence (I, τ) of oxygen is described by the Stern-Volmer equations:

$$\frac{{I}_{0}}{I} = 1 + {K}_{SV} [ {O}_{2} ]$$

$$\frac{{τ}_{0}}{τ} = 1 + {k}_{SV} [ {O}_{2} ]$$

where Kₛᵥ is the Stern-Volmer quenching coefficient having a specific value for each fluorophore/quencher system. [O₂] is the concentration of O₂, and when in gas phase, it is the partial pressure of oxygen (pO₂) and the oxygen solubility (concentration) in water (in ppm) while in aqueous phase.

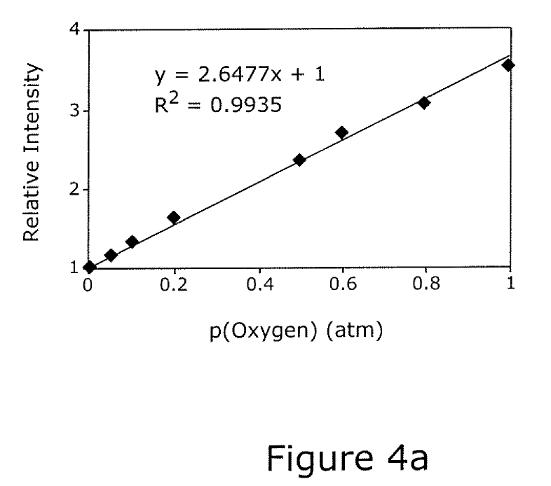

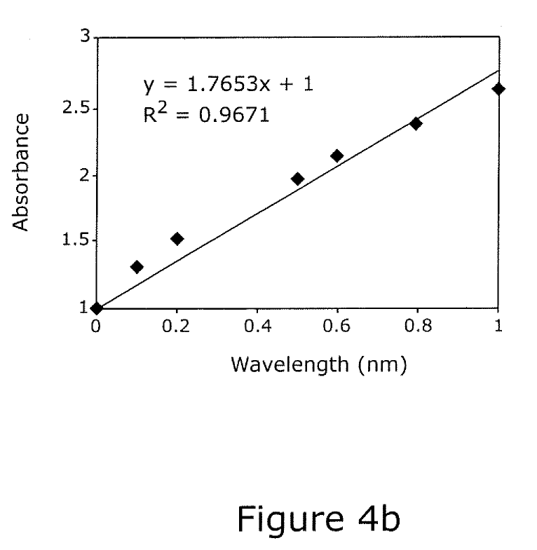

Since oxygen can quench the fluorescence of many fluorophores, the quenching of the fluorescence is used for the detection of oxygen. As discussed above, the intensity or lifetime of the fluorescence decreases when oxygen is present. When the fluorophore is immobilized onto the distal end of a fiber by calibrating the probe with the fluorescence of the fluorophore in the absence and presence of oxygen, the oxygen content in the sample can be determined through the arrangement of the fiber-optic setup, and remote sensing is achieved. The Stern-Volmer plots for the JM-6277 and JM-6280 sensors are shown in FIGS. 4a and 4b, respectively.

### Dyes for the Fabrication of an Oxygen Sensor

A large number of indicators have been used for quenching-based oxygen sensors. These indicators are generally divided into three groups. The first group contains such materials as polycyclic aromatic hydrocarbons (PAH) such as pyrene, pyrenebutyric acid, and perylene dibutyrate (solvent green 5). The second group contains heterocycles such as porphyrins, or other compounds such as luminol, erythrosin B, and alkaline fluorescein. The third group of indicators is the metallorganic coordination compounds of ruthenium, platinum, osmium, palladium, cobalt, gold, and aluminum where the metals are the central atoms. Some proteins can also be used based on their reaction with oxygen, but typically oxygen is consumed. Both the commercially available oxygen sensors and the above-referenced oxygen sensors are generally used for gas phase oxygen or dissolved oxygen at pH values less than 10.

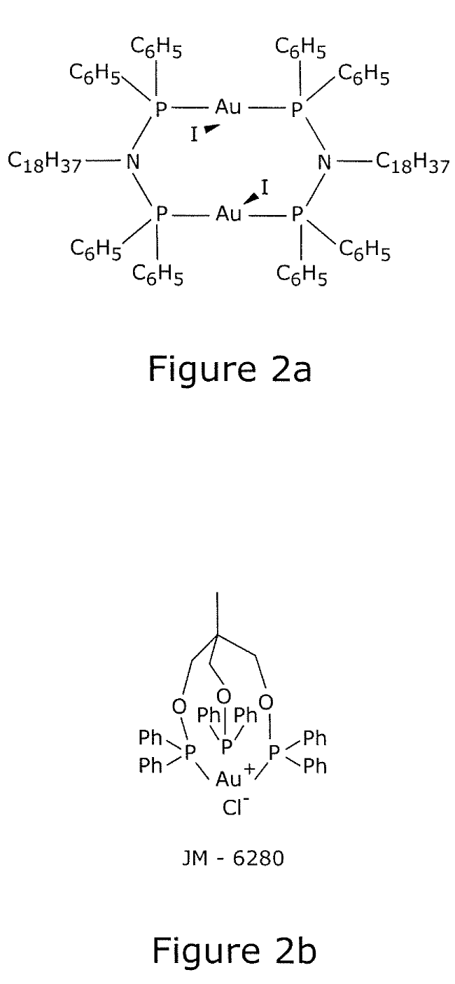

Many of the fiber-optic oxygen sensors are used for monitoring gas phase oxygen. To find out if a luminophore is suitable for fabricating a fiber-optic sensor, it must be determined whether a particular compound has strong luminescence, and whether the luminescence is quenched by oxygen, in either gas or dissolved phases. Typically, a sensor made with this luminophore is first used to test gas phase oxygen. Mills et al. have made thin-film oxygen sensors on glass slides using two gold compounds, i.e., JM-6277 and JM-6280. The structures of the two complexes are shown in FIGS. 2a and 2b, respectively.

Both these compounds exhibit strong luminescence when they are excited and the luminescence is attributable to the triplet to singlet transition (phosphorescence) of the center Au ions. These sensors perform satisfactorily in gas phase oxygen, but much longer recovery time was needed in liquid media with the JM-6280 sensor, especially in aqueous solutions. The fiber-optic sensors of the present invention use these two compounds. These inventive sensors were first tested for gas phase oxygen and then for dissolved oxygen. Comparisons of results obtained from sensors fabricated on the glass slides and results from the optical fiber tips were helpful in estimating the performance of a fiber-optic oxygen sensor from the data of another type (e.g., thin-film) using the same indicator.

In addition, other dyes believed to exhibit fluorescence quenched by oxygen were also tested. These dyes were also used to fabricate oxygen probes, which were tested for sensing oxygen as discussed below.

### Properties of the Dyes

The oxygen sensor tips made from JM-6277 and JM-6280 as shown in FIGS. 2a and 2b, respectively, were first tested for measurement of oxygen in gas phase. In order to find out the excitation and emission wavelengths, the UV and visible (i.e., UV/Vis) spectra of the indicator solutions in polystyrene+dichloromethane were obtained, and the wavelengths were used as the excitation wavelength for the indicators immobilized onto the sensor tips. JM-6277 solution exhibited absorption maximum at 400 nm (set as excitation wavelength) and an emission maximum at 586 nm. JM-6280 solution exhibited absorption maximum at 286 nm (set as excitation wavelength) and an emission maximum at 512 nm, is respectively.

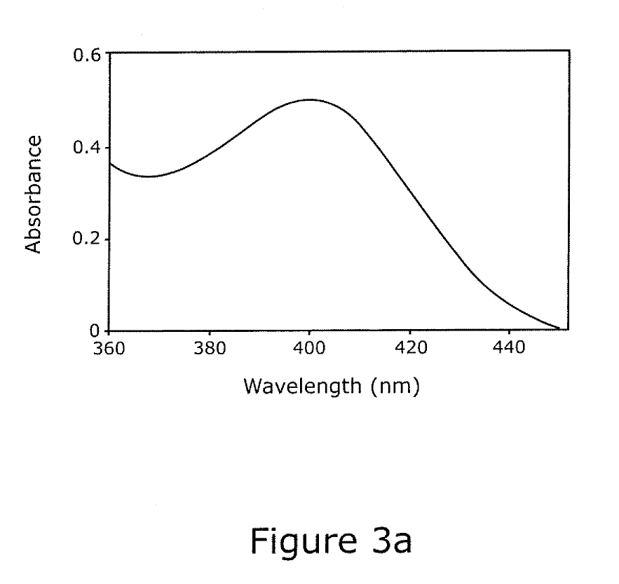

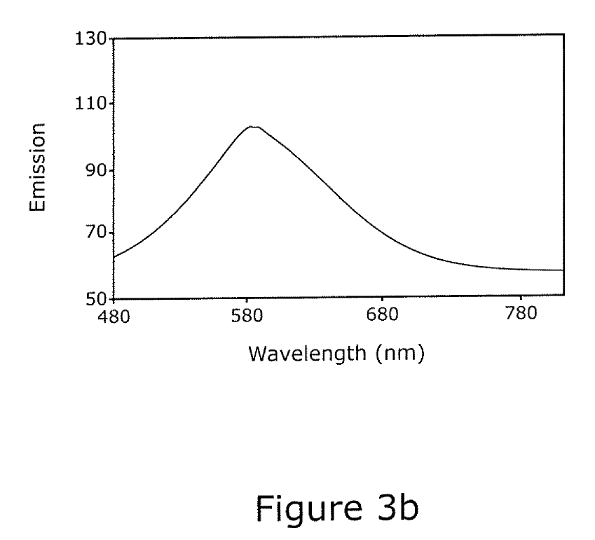

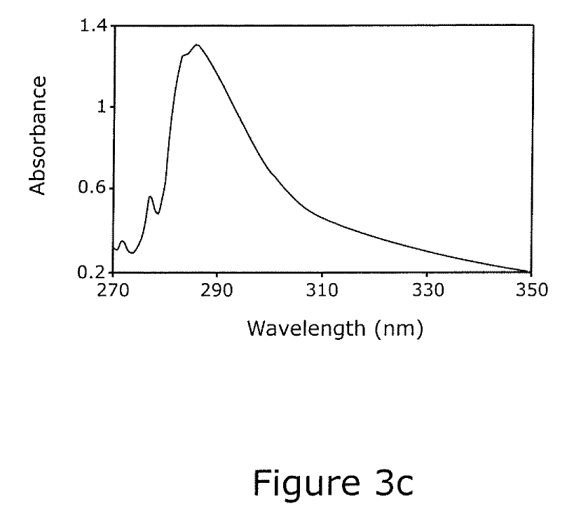

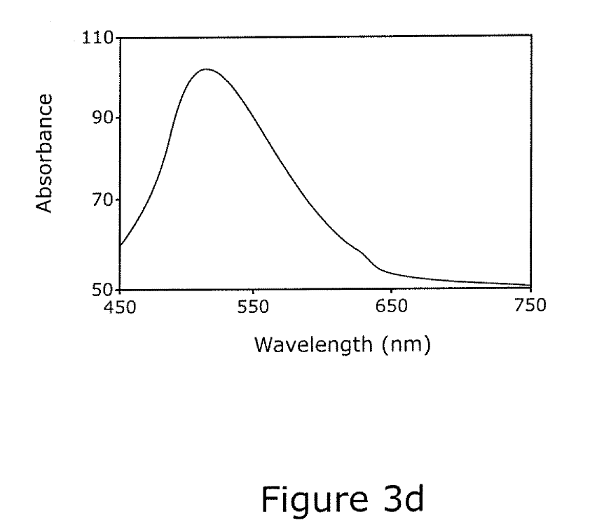

FIGS. 3a, 3b, 3c, and 3d show the spectral characteristics of the indicator solutions and the sensor tips. FIGS. 3a and 3c show the spectrum of the JM-6277 solution on glass slide and immobilized onto the fiber-optic tip, respectively. FIGS. 3b and 3d show the spectrum of the JM-6280 solution on glass slide and immobilized onto the fiber-optic tip, respectively.

### Sensitivity to Oxygen

The luminescence would be quenched by oxygen according to the equation

$$\frac{{I}_{0}}{I} = 1 + {K}_{SV} [ {O}_{2} ] .$$

FIG. 4 shows the Stern-Volmer plots for both the JM-6277 and JM-6280 sensors. Both sensors showed linearity towards oxygen between 0% and 100%. From the slopes of the linear plots, the Kₛᵥ values for JM-6277 and JM-6280 sensors were determined to be 2.6477 and 1.7653 atm⁻¹, respectively.

Mills et al. introduces a parameter, PO₂(S=½), which is the value Of PO₂ required for the luminescence intensity, I, to decrease to a value of I₀/2, to measure the sensitivity of an oxygen sensor. It may be deduced from the equation

$$\frac{{I}_{0}}{I} = 1 + {K}_{SV} [ {O}_{2} ] .$$

This relation would yield the values of

$$p {O}_{2} ( S = \frac{1}{2} )$$

(i.e., that

$$\frac{1}{{K}_{SV}} ,$$

0.378 and 0.566 atm, for JM-6277 and JM-6280, respectively. The comparison between the values of Kₛᵥ for JM-6277 and JM-6280 in the thin-film sensors and in the fiber-optic sensors are shown in TABLE 1.

TABLE 1

Dyes

| | JM-6277 | JM-6280 |
|---|---|---|
| 1/ks,, (atm) (Thin-Film) | 0.246 | 1.46 |
| 1/Ks,, (atm) (Fiber-Optic) | 0.378 | 0.566 |

It may be seen that the sensitivity of the JM-6277 sensor decreased by ⅓ (1/Kₛᵥ increased 50%) while that of JM-6280 sensor increased nearly 3 times (1/Kₛᵥ decreased about 60%) after they were immobilized into the optical fiber tips.

### Response and Recovery

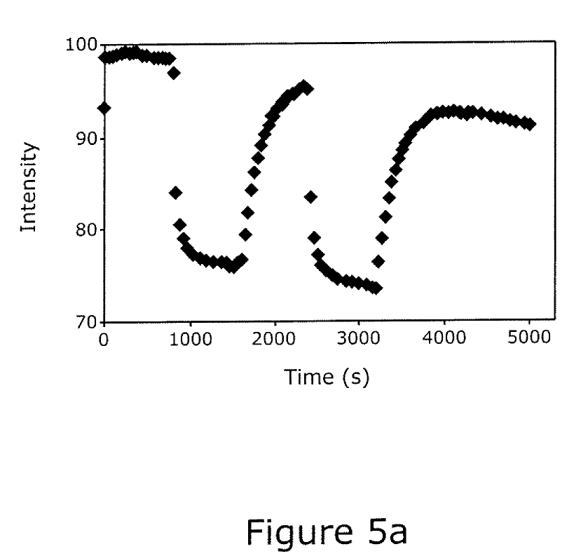

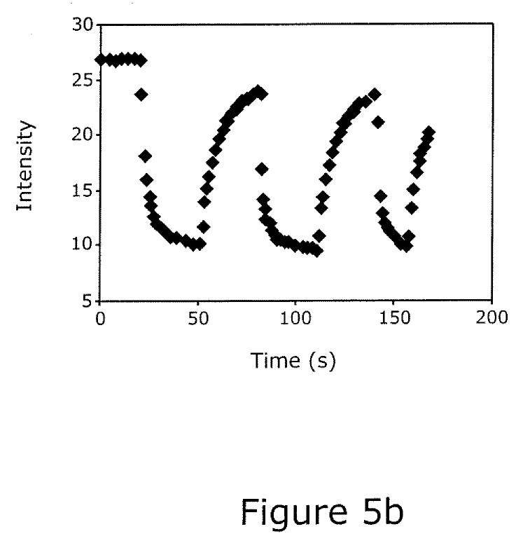

FIGS. 5a and 5b show the real-time response and recovery profiles for JM-6277 and JM-6280 sensors, respectively, by reading the intensity signal when each sensor was exposed to 100% O₂ and 100% N₂, alternatively. The response and recovery time was expressed by 90% response (Kₛᵥ) and 90% recovery (Kₛᵥ), which are defined as values of time for a sensor to achieve its 90% luminescence intensity change. The response and recovery time for the JM-6277 and JM-6280 sensors and the comparison between the time for the fiber-optic and the thin-film sensors are listed in TABLE 2.

TABLE 2

| | JM-6277 | JM-6280 | JM-6277 | JM-6280 |
|---|---|---|---|---|
| Sensors | (Fiber Optic) | (Fiber Optic) | (Thin Film) | (Thin Film) |
| t₉₀ ▾ (s) | 120 | 7 | 26 | 23 |
| t₉₀ ▴ (s) | 320 | 18 | 100 | 71 |

From TABLE 2 it can be seen that, compared to the thin-film sensors, the fiber-optic JM-6277 sensor exhibits longer response time, but the JM-6280 fiber-optic sensor exhibits shorter response time compared to its thin-film counterpart. In other words, its response is much faster than a JM-6280 thin film sensor. Combining the results of sensitivity and response, JM-6280 appears to result in a sensitive fiber-optic sensor.

When the sensors were tested in water solutions, however, there was no significant quenching observed. In addition, the response time of fluorescent signals was very long, up to 30 minutes. This phenomenon was attributed to the low oxygen concentration in aqueous solutions (expressed in ppm level) and the absorbance of light by the silica in the tip that reduced the light intensity to excite the fluorophores.

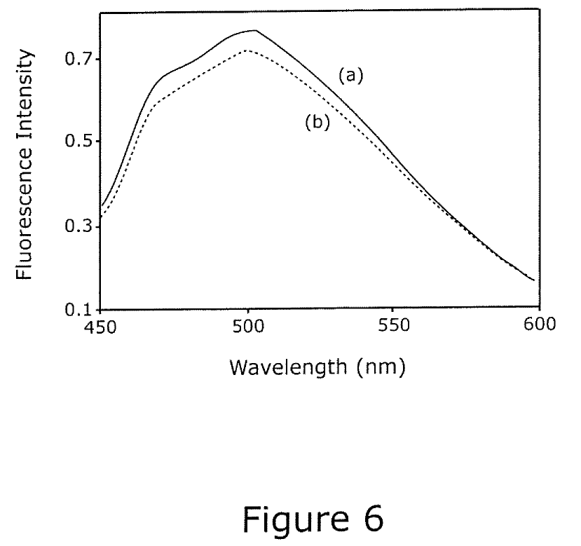

Other fluorophores were also tested for their fluorescence and quenching. First, their chemistry in the solutions was tested. FIG. 6 shows the fluorescence of QABA (4-(3-quinolinoazo) hydroxybenzoic acid) in the dichloromethane solution purged with nitrogen (without oxygen in the solution) and with air (with oxygen in the solution). It was clearly seen that the fluorescence was quenched by oxygen in the solution. But when these compositions were immobilized into the distal end of the tip, there was not much quenching observed. The reason should be that the oxygen concentration in the water solutions is too low, the silica in the sensor absorbs light, and the oxygen diffusing into the film is too little for the quenching to be detected.

Other fluorophores tested include (1) camphorquinone (2) di-isobutyl perylenedicarboxylate, (3) [{fac-Re(CO)3(2,2′-bipyridyl}₂(g-DPB)][PF6], (DPB-4,4′-dipyridylbutadiyne), (4) tris(2,2′-bipyridyl)dichlororuthenium(II) hexahydrate and (5) Os(pyterpy)2(PF₆)₂. While all of these compositions may be quenched by oxygen in solutions, none perform well when they are immobilized onto a fiber-optic tip. TABLE 3 summarizes the performance of the indicators in solutions and when immobilized onto sensor tips.

TABLE 3
Quenching Efficiency (QE) of Indicators

| Luminophore | λₑₓ (nm) | λₑₘ (nm) | QE in solution (%) | QE in film |
|---|---|---|---|---|
| | 470 | 560 | 30 | <1 |
| (2) | 468 | 550 | 30 | <1 |
| (3) | 354 | 532 | 70 | <1 |
| (4) | 470 | 600 | 50 | unstable |
| (5) | 490 | 748 | 19 | <1 |

Where
λₑₓ = excitation wavelength;
λₑₘ = emission wavelength; and
QE = luminescence decrease when exposed to air

### Properties of the Ru (II) Compound for the Oxygen Sensor

After testing many fluorophores, the focus was on the metal complexes, specifically ruthenium complexes. The ruthenium complexes are widely used for oxygen sensing, and the most commonly used are its bipyridyl and phenanthroline (or derivative) complexes, among which tris(4,7-Biphenyl-1,10-phenanthroline) ruthenium (Ru(dpp)₃) is a well-known fluorophore for oxygen sensing. These compounds have strong fluorescence and they are quenched by oxygen.

Tris(2,2′-bipyridyl) dichlororuthenium hexahydrate was tested; however, it is photo-labile and decomposes under light illumination after it is immobilized onto the sensor tip. Tris (4,7 diphenyl-1,10-phenanthroline) ruthenium shows different quenching properties based on the different anions. Its tetraphenylboride (Ru(dpp)₃(B(C₆H₅)₄)₂) was also tested but insufficient quenching by oxygen was observed when the compound was immobilized. The chloride (Ru(dpp)₃Cl₂) has been widely used for detecting oxygen in the gas phase and has also been used to fabricate a sensor for detecting dissolved oxygen.

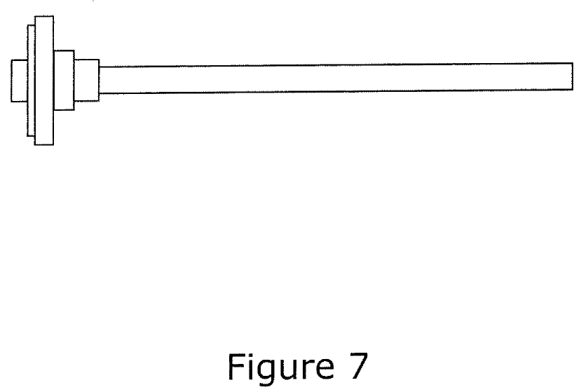

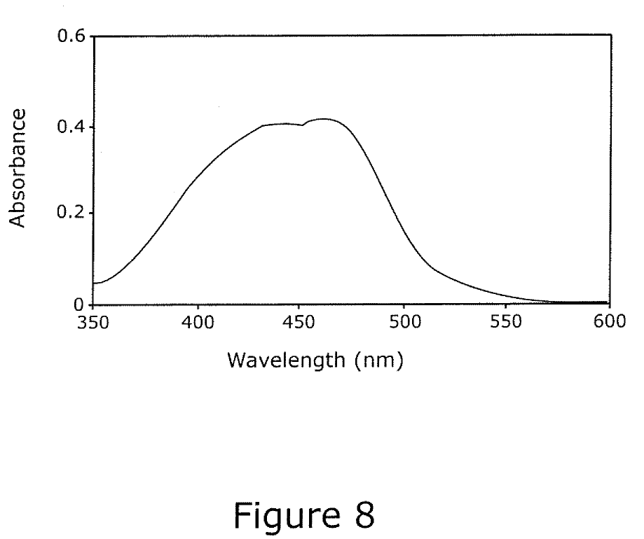

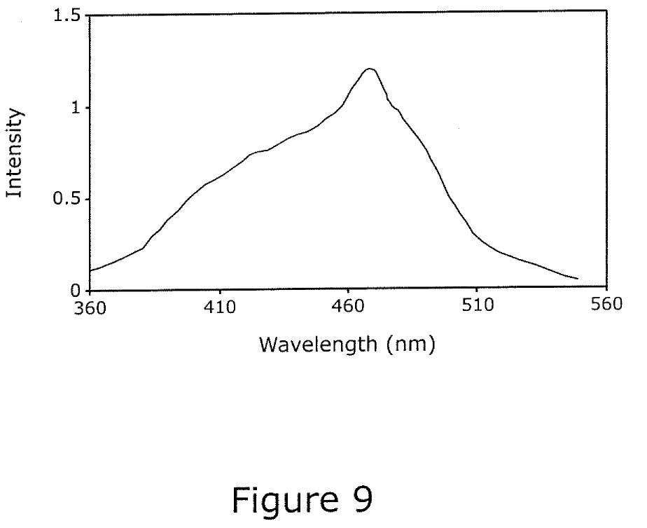

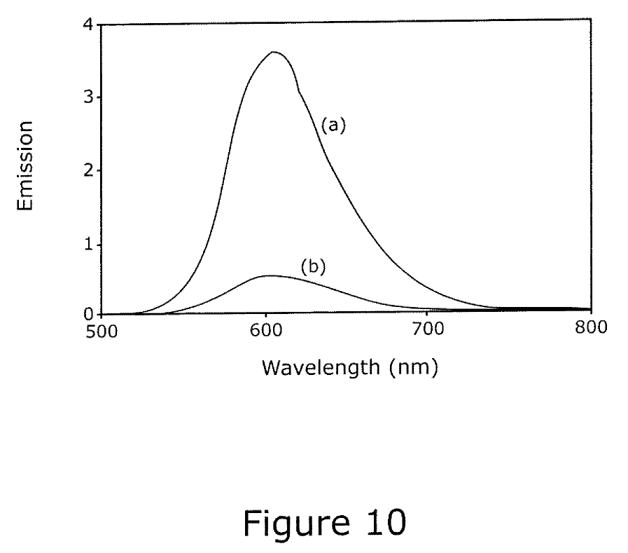

FIG. 7 shows a sensor tip immobilized with Ru(dpp)₃Cl₂. The UV/Vis spectra of Ru(dpp)₃Cl₂ is shown in FIG. 8. The absorption peak wavelength is at 463 nm, which matches that of the OceanOptics blue LED (light emitting diode). The excitation peak wavelength is 470 nm as illustrated in FIG. 9. The fluorescence wavelength is at 604 nm. When (Ru(dpp)₃Cl₂ was immobilized onto the distal end of the OceanOptics tip with polystyrene, the fluorescence peak wavelength is at ˜620 nm (excited at 470 nm of the blue LED). Polystyrene is used because it can withstand the highly alkaline condition in the electroless gold baths. The fluorescence spectra of 1×10-5 M (Ru(dpp)₃Cl₂ in CH₂Cl₂ solution purged with nitrogen and air is shown in FIG. 10. In solution, the indicator was strongly quenched by the oxygen (in air) by about 80%.

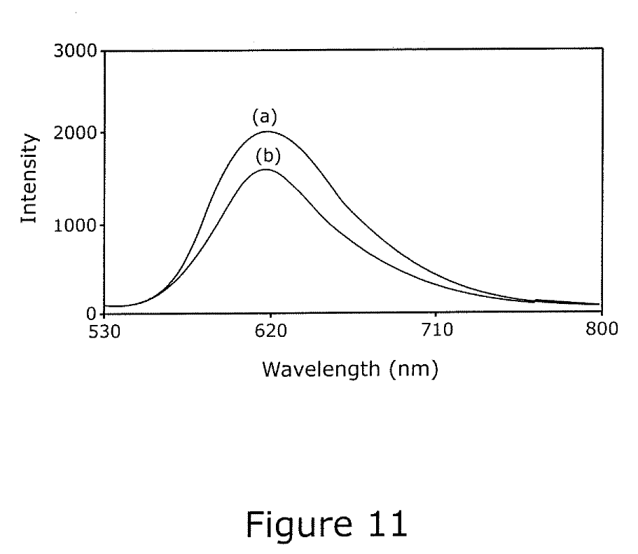

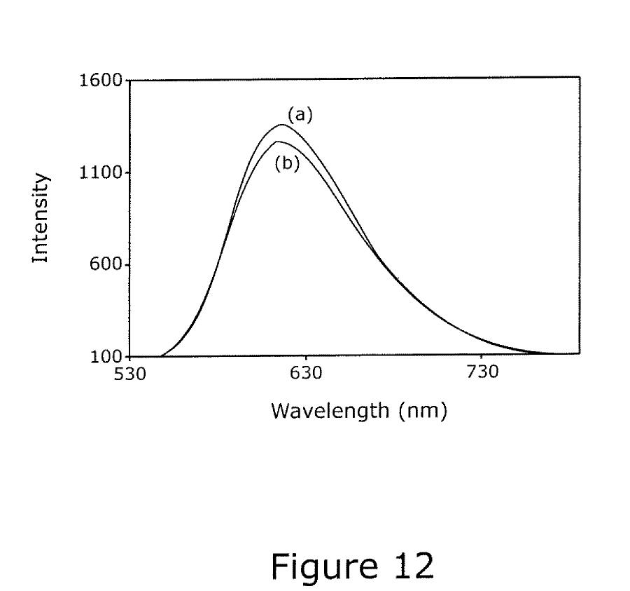

FIG. 11 shows the fluorescence spectra of the sensor in nitrogen and air (with about 20% oxygen). It was found that the fluorescence of the fluorophore immobilized in polystyrene was quenched by oxygen (in air) by about 40%. In aqueous solution, the fluorescence was also quenched by the aqueous oxygen by about 6% (FIG. 12). The oxygen content in Na₂So₃ solution was 0 ppm, and in an air saturated solution, it was 8 ppm. A relative standard deviation of 4.6% was obtained for 6 measurements of an 8 ppm O₂ solution. By setting the detection limit as three times of the standard deviation at 0 PPM O₂ solution, the detection limit was calculated at 0.1 ppm.

### Instrumentation of the Oxygen Sensor System

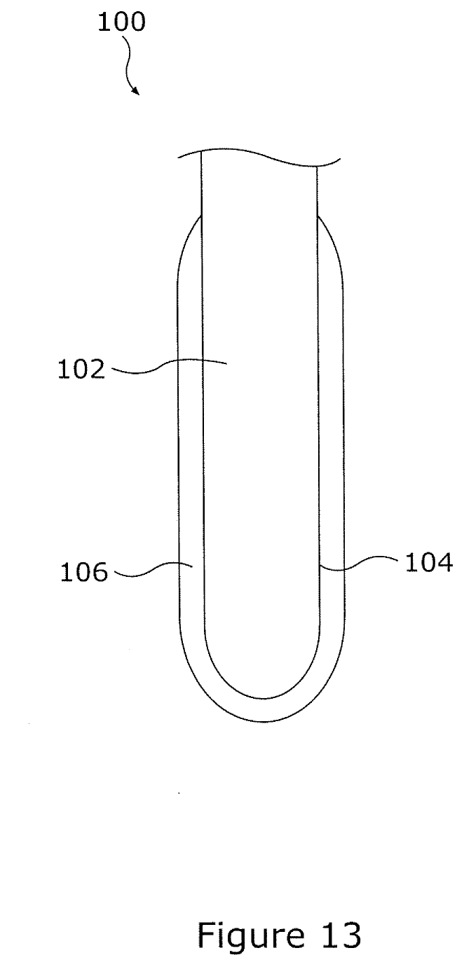

Referring now to FIG. 13, there is shown a front elevational view of a first embodiment of a typical oxygen sensor probe 100, in accordance with the present invention. The probe 100 consists of a stainless steel core 102, typically of cylindrical cross section and having a rounded, distal end 104. Cores of other shapes may, of course, be utilized to meet a particular requirement and the invention is not considered limited to cores having cylindrical cross sections. A rectangular cross section, for example, may provide better reflectivity of the illuminating blue light. Regardless of the shape chosen, substantially laminar flow of the monitored solution should be maintained in the vicinity of the probe 100.

No mounting mechanism for the probe 100 is specifically disclosed and the invention is considered to encompass any suitable method or mechanism for supporting, suspending, and/or securing the probe 100 in its intended operating location.

A coating 106 is disposed on the outer surface of the core 102. While stainless steel has been chosen for purposes of disclosure, it will be recognized that other chemically inert materials may be chosen for the core 102 of the probe 100.

In the embodiment chosen for purposes of disclosure, the coating 106 is an immobilized layer of polystyrene mixed with a fluorophore (e.g., Ruthenium tris(4,7-diphenyl-1,10-phenanthroline) dichloride coated from a solution of the polystyrene/fluorophore in a solvent such as dichloromethane. It will be recognized that there may be alternative fluorophores which may be used, and the invention is not considered limited to the particular formulation utilized for purposes of disclosure. The mixture may be coated onto the core 102 by dipping, spraying, or any other process suitable for applying a uniform coating to the core 102. The coated core 102 is then typically air-dried overnight. It will also be recognized that other drying methods known to those skilled in the coating arts may be used to speed the drying process. After drying, the sensor probe 100 is ready for use.

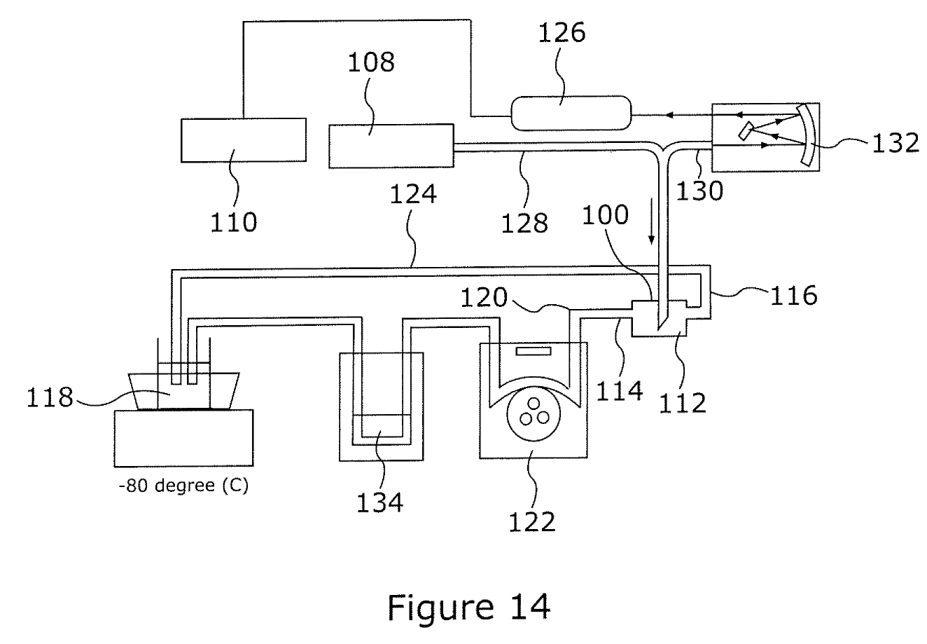

Refer now also to FIG. 14 where there is shown a schematic system block diagram of probe 100 in its intended operating environment. To monitor the oxygen in the electroless gold bath on-line, it was necessary to design a system with which oxygen can be detected in real time. The bath solution 118 should be delivered to the sensor 100 substantially continuously, the oxygen therein detected, and then allowed to flow back to the bath or be discarded. To achieve this approach, a peristaltic pump 122 (Amko Systems Inc., Ontario, Canada) was used to drive the solution 118 to the sensor and back to the bath. Also, during the detection, the effect of the ambient light had to be eliminated. A flow cell 112 was used that allowed the sensor 100 to be inserted into the flow cell 112. Consequently, during monitoring, the sensor 100 was adequately shielded from ambient light. Therefore, no second layer, such as black silicone, was required. It will be recognized that additional light shielding could be added if required to meet a particular operating circumstance or environment.

Probe 100 must be combined with a light source 108, a photodetector 126, and a spectrophotometer detector 110 to complete the inventive oxygen sensor system. In the embodiment chosen for purposes of disclosure, an LED emitting light having a wavelength of approximately 470 nM is used for a light source 108. It will be recognized that other light sources and/or other light wavelengths could likewise be used. A photodetector 126 is provided to receive light emitted by coating 106 of probe 100. In the preferred embodiment, the photodetector comprises an array of photo diodes 126. However, it will be recognized that other photodetectors may be suitable. A Model SL 2000 spectrophotometer, manufactured by OceanOptics, has been found suitable for the application. Spectrophotometers are well known to those skilled in the art, and any suitable spectrophotometer may be used.

Both light source 108 and photodetector 126 (e.g., diode array) are typically coupled to probe 100 by optical fibers 128, 130, respectively. In some embodiments, additional optical components may be placed in the path of light emitted by probe 100. For example, a grating 132 is shown. Other optical components (not shown) may be required or desirable in alternate embodiments of the inventive oxygen sensor system.

When required, a monitored solution may be passed through an ice bath 134 or other suitable cooling system to reduce the temperature of fluid 118 before passing it to the pump 122 and flow cell 112.

In typical use, the inventive sensor probe 100 is inserted into and retained within a flow cell 112. In the embodiment chosen for purposes of disclosure, flow cell 112 is made from stainless steel. Flow cell 112 has a solution inlet 114 and a solution outlet 116. The solution 118 to be monitored flows through the flow cell 112 around the probe 100. In operation, the fluorophore layer 104 of the inventive probe 100 is illuminated by blue light from the LED 108 and the fluorescence of the coating 104 of the probe 100 is reflected to photodetector 126 whose output signal is coupled with spectrophotometer 110 for analysis.

The monitored solution 118 is pumped from the desired area of the process equipment (e.g., the plating bath) by a pump 122 and through an intake conduit 120. The outlet of the pump 122 is connected to an inlet 114 of the flow cell 112. The solution 118 flows through the flow cell 112 (i.e., around the probe 100) and is discharged from the flow cell 112 through an outlet 116. The analyzed solution 118 returns, typically to the solutions point of origin, through a conduit 124. A typical solution 118 is an electroless gold plating bath. Using the inventive sensor, real-time, on-line detection of the oxygen in the monitored solution 118 is achieved, and none of the solution 118 is either consumed or contaminated. The ease of fabrication of the probe and the simplicity of its installation make the inventive probe suitable for on-line industrial application. The on-line detection eliminates the time and possible contamination in preparing industrial samples typical in oxygen measurements of the prior art.

One of the major advantages of this oxygen sensor is that it can be used in a highly alkaline matrix as high as pH 14. Current commercial oxygen sensors have problems with solutions having a pH greater than 9.0. The inventive sensor is also suitable for neutral solutions.

The oxygen sensor system of the instant invention is an analytical module fabricated from a fluorescent compound, a loop-shaped cycling system, and a UV or visible light source with spectrophotometer. The detection of oxygen in the sample solution (e.g., solution 118) is realized by the fact that the fluorescence of the coating 104 of the probe 100 is quenched in the presence of dissolved oxygen in the solution. The fluorescence is quenched depending on the concentration of dissolved oxygen in the solution.

The probe is also able to withstand the high alkalinity characteristic of industrial electroless gold bath and similar solutions. The loop-shaped cycling system enables the recycling of the sample solution; therefore, the invention can detect oxygen content in the sample on-line, and at the high alkaline pH typically found in electroless gold baths (or other neutral dissolved oxygen), it can be quickly detected, typically in less than three minutes. The results are comparable in accuracy to those obtained using a Clarke electrode-based oxygen sensor system.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of the invention.

Having thus described the invention, what is desired to be protected by Letters Patent is presented in the subsequently appended claims.

What is claimed is:

1-8. (canceled)

9. A system for detecting oxygen in a sample liquid, comprising:
a) a probe comprising a core coated with a polymer and (4-(3-quinolinoazo) hydroxybenzoic acid);
b) a flow cell containing the liquid sample in which said probe is immersed;
c) a light source positioned to project light of a fixed, predetermined wavelength onto said coated probe;
d) a photodetector disposed to receive light caused by fluorescence of said coated probe when illuminated by said light source; and
e) a circulation system suitable for circulating the sample liquid through said flow cell and maintaining a level of sample liquid in said flow cell which will immerse said probe.

10. The system as recited in claim 9, wherein said light source comprises an LED.

11. The system as recited in claim 10, wherein said LED generates light having a wavelength of approximately 470 nM.

12. The system as recited in claim 9, wherein said photodetector comprises an array of photo diodes.

13. The system as recited in claim 9 further comprising:
a spectrophotometer coupled to said photodetector.

14. The system as recited in claim 9 further comprising:
optical fibers coupling said light source to said flow cell.

15. The system as recited in claim 9 further comprising:
a grating coupling the probe to the photodetector.

16. The system as recited in claim 9 further comprising:
optical fibers coupling said flow cell and said grating.

17. The system as recited in claim 9, wherein the circulation system comprises:
a cooling system.

18. The system as recited in claim 9, wherein the circulation system comprises:
a pump to circulate liquid between said cooling system and said flow cell.

19. A method of measuring oxygen in a sample liquid with a pH above 9.0 comprising:
providing the system of claim 9;
passing a sample liquid with a pH above 9.0 through the flow cell;
contacting the sample liquid with the probe;
projecting light from the light source onto said probe; and
detecting light caused by fluorescence of said probe when illuminated by said light source thereby measuring oxygen in the sample liquid.

20. The method of claim 19, wherein said circulation system is operated under conditions effective to maintain a level of sample liquid in said flow cell which will immerse said probe.

21. The method of claim 19, wherein the sample liquid has a pH up to 14.
